(19) United States
(12) Patent Application Publication
(10) Pub. No.: US 2008/0059468 A1
(43) Pub. Date: Mar. 6, 2008

(54) METHOD, SYSTEM, AND PROGRAM PRODUCT FOR GROUPING STATEMENTS AGAINST DATABASE OBJECTS

(76) Inventor: Michael Bender, Rye Brook, NY (US)

Correspondence Address: HOFFMAN, WARNICK & D'ALESSANDRO LLC, 75 STATE ST, 14TH FLOOR, ALBANY, NY, 12207, US

(21) Appl. No.: 11/466,661

(22) Filed: Aug. 23, 2006

(51) Int. Cl. G06F 17/30

(52) U.S. Cl. 707/8

(57) ABSTRACT

The present invention provides a method, system, and program product for grouping statements against database objects. Specifically, under the present invention, a set of statements against a database object are preceded by a start command, and then followed with an end command so that the set of statements will be treated as a single, distributed unit of work. Specifically, the start of this work against the database object would allow for a Data Manipulation Language (DML) command to signal to the target table that a distributed unit of work was starting. After the completion of the (e.g., insert, update and delete) statements another DML command would be issued that would signal the end of the logical unit of work.

### BACKGROUND OF THE INVENTION

1. Field of the Invention

The present invention generally relates to data warehousing. Specifically, the present invention provides a method, system, and program products for grouping statements against database objects as a single, distributed unit of work.

2. Related Art

In the database management arena, processing distributed transactions is geared towards small single transactions, such as a single SQL statement or a processing of an XML file. However, there are a large number of tools that execute multiple SQL statements in order to process what is a logical unit of work. Tools such as Lotus Enterprise Integrator (LEI), WebSphere DataStage (both of which are commercially available from International Business Machines Corp of Armonk, N.Y.), are geared to moving and manipulating data in from a distributed platform. These tools issue multiple insert, update and delete statements against a single table. An example of this is when one of these tools issues a delete statement to empty out a table, and then a sequence of insert statements to populate the table.

There are multiple drawbacks to this current solution. First, when the populating of the table is halted due to a communication or SQL error, there is no way for the target database user to know that this table is in error. Comparing this to a standard DB2 load utility, the target table would be left in a “LOAD PENDING” status. Any user that attempted to query the table would get an error message that notified them of this problem.

Another problem is the inefficiencies of maintaining the indices for a table with a large number of inserts, deletes or updates. Specifically, after each SQL statement is processed, all of the indices for a table are maintained. Still yet, another problem is that the users querying the table for reloading can force these distributed tools to fail due to page locks.

In view of the foregoing, there exits a need for a solution that solves at least one of the deficiencies in the related art.

### SUMMARY OF THE INVENTION

The present invention provides a method, system, and program product for grouping statements against database objects. Specifically, under the present invention, a set of statements against a database object are preceded by a start command, and then followed with an end command so that the set of statements will be treated as a single, distributed unit of work. Specifically, the start of this work against the database object would allow for a Data Manipulation Language (DML) command to signal to the target table that a distributed unit of work was starting. After the completion of the (e.g., insert, update and delete) statements another DML command would be issued that would signal the end of the logical unit of work.

A first aspect of the present invention provides a method for grouping statements against database objects, comprising: issuing a start command prior to a start of a set of statements against a database object; and issuing an end command after an end of the set of instruction so that the set of statements is grouped as a single unit of work against the database object.

A second aspect of the present invention provides a system for grouping statements against database objects, comprising: a system for issuing a start command prior to a start of a set of statements against a database object by a user; a system for protecting the database object from statements issued by other users; and a system for issuing an end command after an end of the set of instruction so that the set of statements is grouped as a single unit of work against the database object.

A third aspect of the present invention provides a program product stored on a computer readable medium for grouping statements against database objects, the computer readable medium comprising program code for causing a computer system to perform the following: issue a start command prior to a start of a set of statements against a database object by a user; protect the database object from statements issued by other users; and issue an end command after an end of the set of instruction so that the set of statements is grouped as a single unit of work against the database object.

A fourth aspect of the present invention provides a method for deploying a system for grouping statements against database objects, comprising: providing a computer infrastructure being operable to issue a start command prior to a start of a set of statements against a database object; and issue an end command after an end of the set of instruction so that the set of statements is grouped as a single unit of work against the database object.

Therefore, the present invention provides a method, system, and program product for grouping statements against database objects.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for remotely attesting to the state of a computer system according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and program product for grouping statements against database objects. Specifically, under the present invention, a set of statements against a database object are preceded by a start command, and then followed with an end command so that the set of statements will be treated as a single, distributed unit of work. Specifically, the start of this work against the database object would allow for a Data Manipulation Language (DML) command to signal to the target table that a distributed unit of work was starting. After the completion of the (e.g., insert, update and delete) statements another DML command would be issued that would signal the end of the logical unit of work.

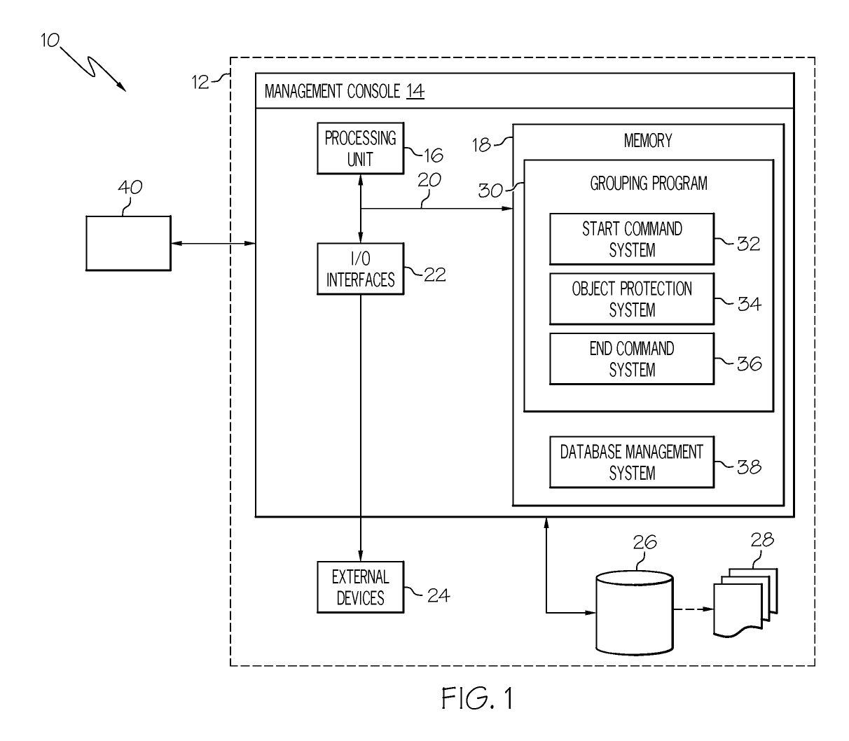

Referring now to FIG. 1, a system 10 for grouping statements against database objects according to the present invention is shown. As depicted, system 10 includes a computer system 14 deployed within a computer infrastructure/environment 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to group statements against database objects according to the present invention.

As shown, computer system 14 includes a processing unit 16, a memory 18, a bus 20, and input/output (I/O) interfaces 22. Further, computer system 14 is shown in communication with external I/O devices/resources 24 and storage system 26. In general, processing unit 16 executes computer program code, such as grouping program 30 and/or Data Manipulation program (DML) program 38, which are stored in memory 18 and/or storage system 26. While executing computer program code, processing unit 16 can read and/or write data to/from memory 18, storage system 26, and/or I/O interfaces 22. Bus 20 provides a communication link between each of the components in computer system 14. External interfaces 24 can comprise any devices (e.g., keyboard, pointing device, display, etc.) that enable a user to interact with computer system 14 and/or any devices (e.g., network card, modem, etc.) that enable computer system 14 to communicate with one or more other devices.

Computer infrastructure 12 is only illustrative of various types of computer infrastructures for implementing the invention. For example, in one embodiment, computer infrastructure 12 comprises two or more devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose providing article of manufacture comprising hardware and/or computer program code for performing specific functions, any providing article of manufacture that comprises a combination of specific purpose and general purpose hardware/software, or the like. In each case, the program code and hardware can be created using standard programming and engineering techniques, respectively. Moreover, processing unit 16 may comprise a single processing unit, or be distributed across one or more processing units in one or more locations, e.g., on a client and server. Similarly, memory 18 and/or storage system 26 can comprise any combination of various types of data storage and/or transmission media that reside at one or more physical locations. Further, 20 interfaces 22 can comprise any system for exchanging information with one or more external interfaces 24. Still further, it is understood that one or more additional components (e.g., system software, math co-processing unit, etc.) not shown in FIG. 1 can be included in computer system 14. However, if computer system 14 comprises a handheld device or the like, it is understood that one or more external interfaces 24 (e.g., a display) and/or storage system 26 could be contained within computer system 14, not externally as shown.

Storage system 26 can be any type of system (e.g., a database) capable of providing storage for information under the present invention. To this extent, storage system 26 could include one or more storage devices, such as a magnetic disk drive or an optical disk drive. In another embodiment, storage system 26 includes data distributed across, for example, a local area network (LAN), wide area network (WAN) or a storage area network (SAN) (not shown). It should be understood that although not shown, additional components, such as cache memory, communication systems, system software layers (e.g., BIOS, Boot, etc.) may be incorporated into computer system 14.

Shown in memory 18 of computer system 14 is grouping program 30 and database management system 38. Grouping program 30 includes start command system 32, object protection system 34, and end command system 36. It should be appreciated that the same functionality could be implemented with a different configuration of systems and/or sub-systems than is shown in FIG. 1. This depiction is intended to be illustrative only.

As indicated above, the present invention, allows grouping of statements against database objects 28. Specifically, assume that user 40 wishes to perform a set (e.g., one or more) of operations against a database object 28. Further assume that that user 40 wishes for the database object to be at his/her exclusive disposal while the operations are being performed. User 40 will initially issue a set of statements corresponding to the desired operations against database object 28 using DML, or the like. Upon receipt, start command system 32 will issue a start command that appears just before the start of the set of statements. The start command would thus act as a “flag” that indicates the start of the set of statements. An illustrative start command is shown below:

### START DISTRIBUTED UNIT OF WORK ON DATABASE OBJECT <WITH FORCE, DELAY INDEX>

The execution of the start statement would notify database management system 38 that a single and/or distributed unit of work was starting on the specified database object 28. At this point, the command also allows object protection system 34 to protect database object 28. For example, object protection system 34 could have database management system 38 “lock” object 28, force all other users off of the object, and/or delay the maintenance of the indices until after the unit work was completed (i.e., the set of statements was completely processed).

After the issuing of this command, the issue insert, update or delete statements could then be made against database object 28 without worry about contention from other users. If an error forced a halt to the unit of work, then no users would need worry about the quality of the data. Upon completion of the unit of work (set of statements), end command system would issue an end command to signal the end of the work. The end command would thus function as a “flag” that signals/follows the end of the set of statements and can resemble the following:
END DISTRTBUTED UNIT OF WORK ON DATABASE OBJECT <WITH RUNSTATS>

This would free up all locks on database object 28. It would also give the calling tool the option of updating statistics on the object, as there could have been drastic changes to the table based on this load. At this point, database object 28 would be available to users the same as if a DB2 utility had been executed locally as opposed to the distributed calls that make up a distributed unit of work.

While shown and described herein as a method and system for grouping statements against database objects, it is understood that the invention further provides various alternative embodiments. For example, in one embodiment, the invention provides a computer-readable/useable medium that includes computer program code to enable a computer infrastructure to group statements against database objects. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a providing device, such as memory 18 (FIG. 1) and/or storage system 26 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to group statements against database objects. In this case, the service provider can create, maintain, support, etc., a computer infrastructure, such as computer infrastructure 12 (FIG. 1) that performs the process of the invention for one or more customers. In return, the service provider can receive payment from the target organization(s) under a subscription and/or fee agreement and/or the service provider can receive payment from the sale of advertising content to one or more third parties.

In still another embodiment, the invention provides a computer-implemented method for grouping statements against database objects. In this case, a computer infrastructure, such as computer infrastructure 12 (FIG. 1), can be provided and one or more systems for performing the process of the invention can be obtained (e.g., created, purchased, used, modified, etc.) and deployed to the computer infrastructure. To this extent, the deployment of a system can comprise one or more of (1) installing program code on a providing device, such as computer system 14 (FIG. 1), from a computer-readable medium; (2) adding one or more devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a providing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular providing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

I claim:

1. A method for grouping statements against database objects, comprising:
issuing a start command prior to a start of a set of statements against a database object; and
issuing an end command after an end of the set of instruction so that the set of statements is grouped as a single unit of work against the database object.

2. The method of claim 1, wherein the start command is associated with a particular user, and wherein the method further comprises protecting the database object from statements issued by users other than the particular user.

3. The method of claim 2, wherein the protecting comprises at least one of the following, locking the database object, or delaying indexing on the database object.

4. The method of claim 1, wherein the set of statements comprise a plurality of statements.

5. A system for grouping statements against database objects, comprising:
a system for issuing a start command prior to a start of a set of statements against a database object by a user;
a system for protecting the database object from statements issued by other users; and
a system for issuing an end command after an end of the set of instruction so that the set of statements is grouped as a single unit of work against the database object.

6. A program product stored on a computer readable medium for grouping statements against database objects, the computer readable medium comprising program code for causing a computer system to perform the following:
issue a start command prior to a start of a set of statements against a database object by a user;
protect the database object from statements issued by other users; and
issue an end command after an end of the set of instruction so that the set of statements is grouped as a single unit of work against the database object.
